(19) United States
(12) Patent Application Publication
(10) Pub. No.: US 2007/0082653 A1
(43) Pub. Date: Apr. 12, 2007

(54) System and method for managing emergency situations through a mobile terminal

(76) Inventor: Gaetano Rizzi, Busto Arsizio (IT)

Correspondence Address: NEIL A. STEINBERG, 2665 MARINE WAY, SUITE 1150, MOUNTAIN VIEW, CA, 94043, US

(21) Appl. No.: 10/579,939

(22) PCT Filed: Jul. 14, 2004
(86) PCT No.: PCT/IB04/02292

§ 371 Date: May 19, 2006

(30) Foreign Application Priority Data
Nov. 24, 2003 (IT) MI2003A002283

(51) Int. Cl. H04M 11/04

(52) U.S. Cl. 455/404.2

(57) ABSTRACT

A system is described, and the corresponding method, for the management of emergency situations by means of a mobile terminal (1) with an electronic, board (2), apt to implement access functions to a mobile phone network and comprising memory areas (23), containing personal data of the owner of said electronic board (2). The invention consist in that said electronic board (2) shows aid functions which make it at least partially operative when said mobile terminal operates in an emergency state.

The invention concerns a system, and the corresponding method, for the management of emergency situations by means of a mobile terminal.

It is worldwide known to define one or more phone helping numbers to be used in emergency situations, for instance in Italy the 118 (first aid), the 112 (‘carabinieri’), and the 113 (police). The existence of said help numbers however is of no help in the case of an accident or a dangerous situation, wherein the user of a mobile terminal, for instance a mobile phone, or a palmtop computer with means for the mobile radio connection is unable to connect and communicate with the rescuers.

The rescuers in such a case could be called by the person which gives the first aid, but the user of the mobile terminal might be in a situation where he or she is unable to indicate to the rescuer possible disease, like an allergy or a symptomatology affecting the person to be aided. In this way it is therefore not possible to organize a customized aid, which takes into account the medical situation of the person to be aided.

In order to improve and customize the aid, it is known from the German patent DE 199 57 651, the idea of using an electronic board such as a SIM (Subscriber Identify Module) card, which, besides the data necessary to access in an authorized and controlled way to a mobile phone network, it contains personal data of the owner, name, surname, sex, date of birth, address, blood group, allergies, etc. . . . In the German patent, such a SIM card is called SIM-H. The basic idea of the German patent, is that of being able to make, besides the normal calls to the number 112, the German number for the first aid, also particular help calls, which provide, besides from connecting the caller to the help center, also the transmission of the personal data stored in the SIM-H, and the position of the caller. According to what described in the patent, for obtaining such aim, it is provided the use of mobile terminals, mobile phones or palmtop computers, capable of communicating on a mobile phone network and equipped with GPS system, indispensable for individuating the position. When the user dials a special number, for instance 112333, besides the call to the help center, also the position data, obtained through the GPS, and the personal data, obtained from the SIM-H, are transmitted.

The DE 199 57 651 patent foresees also a solution wherein an impact sensor, located on a vehicle, can automatically send an emergency message with the personal data and the position of the user.

The above said known solution has a number of drawbacks, first of all that of allowing customized help only in the case when said mobile terminal is able to make an emergency call to the number 112333.

In the case of a user of the mobile phone network trying to get help, according to the prior art, it is necessary that he or she can switch on the phone, if it is off, remember and dial the PIN code, and dial the special number 112333. Otherwise he or she could only call the 112, a number which does not require the SIM card.

Should the person needing aid, after an accident, be unconscious and should the mobile terminal (e.g. mobile phone) be off or broken, a person which is nearby cannot in any way use the SIM-H card to ask a targeted help for the injured person, because after inserting the SIM-H card in his mobile phone, he should dial a PIN code which he does not know. The SIM-H card in fact, according to the Standard procedures of the known SIM cards, is enabled only if the correct PIN code is dialed, otherwise it blocks and from the keyboard of the mobile terminal you may only make emergency calls to a number which has been memorized into a memory area of the mobile terminal, such as the 112. In any case it is not possible to access the data contained in the SIM card, and therefore it is not possible to make aid calls sending the personal data stored in the SIM-H.

Moreover, said patent hints also at the possibility of installing on motor vehicles a system which automatically activates an emergency call in case of an accident. Such a system however is not described, and therefore it is not clear how the system can distinguish whether there is a real need of aid, or the matter is only of a light bumping between cars. Said system for motor vehicles would then start off a rescue operation also in the case of a light bumping, or in the case a parked car is involved in a collision without a person being in it; therefore the system of the patent DE 199 57 651 would needlessly overcharge the first aid center, so that it could not operate in the case of real need.

In the case then of an electronic SIM-H card used in the mobile terminal of a user, the additional drawbacks, with respect to the mentioned main problems, are due to the limited memory of the SIM-H card, which can contain a limited amount of personal data to be sent to the first aid center.

A further drawback is given by the need of having very expensive and complicated mobile terminals, equipped with GPS systems for detecting the position. The use of the GPS system, not only increases the cost of the mobile terminal and of the system as a whole, but also it adds very strong restriction to the use of the system described in the German patent DE 199 57 651: in some areas of the territory, as for instance road tunnels or town streets passing between great buildings, even if there is a radio coverage by the mobile phone network, it is not possible to detect the position by means of the GPS system, so that the SIM-H card would not be able to make an emergency call, due to the lack of the basic data, i.e. which is the position of the caller. The system described in the German patent cannot therefore be easily used in the streets of a great town, where the GPS system is not working well, but only in open country.

The aim of the present invention is that of solving said problems of the prior art, in particular the main aim is that of allowing customized first aid calls in any situation, even if the person needing help happens to be in the streets of a city or inside a tunnel. In particular the aim of the present invention is that of allowing the first rescuer to have information about the person to be aided, even when the mobile terminal containing the electronic card (2), equipped with the aid functions, is located in an area without radio coverage, or it is in an emergency state, such as it cannot utilize all its functions, due to lack of the personal identification code (PIN). A further aim is that of indicating a system and/or a method capable of allowing emergency calls by means of Standard mobile terminals, namely not particularly designed for this purpose and without GPS systems.

Such aims are obtained by means of a system or a method according to the attached claims, which have to be considered as an integral part of the present description.

In particular such aims are obtained by means of a system for the management of emergency situations through a mobile terminal, equipped with an electronic card apt to implement access functions to a mobile phone network, and comprising memory areas containing personal data of the owner of said electronic card, said system is characterized in that said electronic card has aid functions, which make it at least partially operative when said mobile terminal is operating in emergency conditions.

Advantageously said aid functions comprise the function of displaying said personal data on a display of said terminal and/or the function of transferring said personal data into a memory area of said mobile terminal.

Further aims and advantages of the present invention will be clearer after the following detailed description and from the attached drawings, which are given only as non limiting examples, wherein:

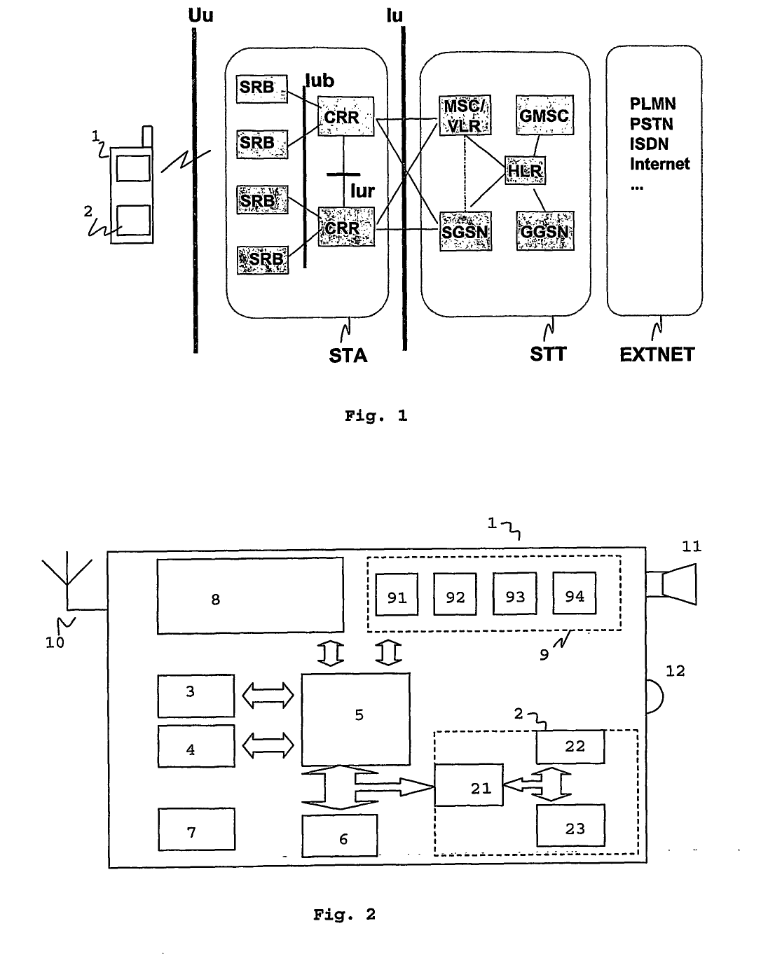

FIG. 1 schematically shows a mobile terminal accessing a mobile phone network.

FIG. 2 schematically shows a few components of a mobile terminal.

FIG. 3 shows the architecture of a system used to implement the method.

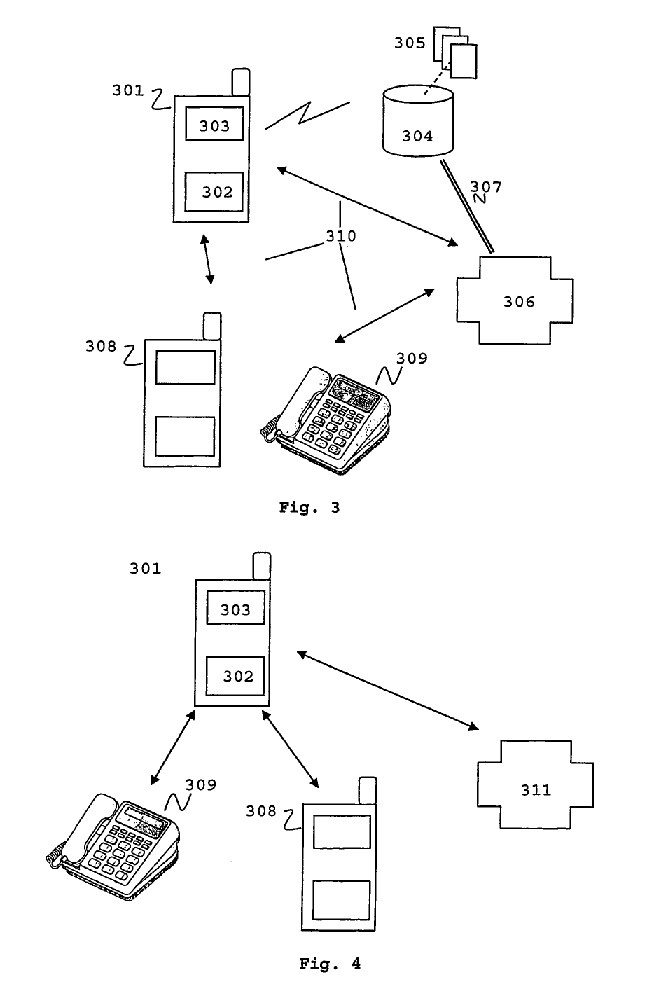

FIG. 4 shows a second possible architecture of a system used to implement the method.

In FIG. 1 there is shown a diagram of the architecture of a mobile phone network according to the prior art. In FIG. 1 it is also shown a mobile terminal (1), accessing said mobile phone network, in particular said terminal comprises an electronic card, known as SIM (Subscriber Identification Module) in the GSM Standard and USIM in the UMTS Standard, apt to implement access functions to a mobile phone network.

The mobile phone network comprises two main subsystems:
An access subsystem STA. Said access subsystem STA constitutes the access network, such as the network through which the mobile terminals can access the available services of the mobile phone network. Said subsystem communicates, on the one side, with the mobile terminal through a user interface (Uu), and, on the other side, it communicates with a transport network STT through a transport-access interface (Iu);
A transport subsystem STT. Said transport subsystem STT, identified as Core Network in the UMTS Standard, constitutes the transport network of mobile phone network. Said transport subsystem STT, besides being interconnected through the transport-access interface (Iu) to the access subsystem STA, shall interconnect to all the other existing networks (e.g. PSTN, ISDN, B-ISDN Internet, etc.), which are identified in FIG. 1 by an EXTNET block. In said transport subsystem STT there are comprised means for sorting the information which are proper of the known mobile phone networks, such as communication center MSC (Mobile services Switching Center), a database HLR (Home Location Register) and a database VLR (Visitor Location Center), an interconnection gateway GMSC (Gateway Mobile Switching Center), a node for managing the packet switching SGSN (Serving GPRS Support Node) or GGSN (Gateway GPRS Serving/Support Node).

In FIG. 1, it is possible to observe, inside the access subsystem STA, a number of radio base stations SRB, which correspond to the base stations defined as Node_B in the UMTS Standard, that is the radio stations scattered on the territory, identifying the cells or domains of the mobile phone network. Their main function consists therefore in exchanging through the radio interface Uu the data and voice signals with the mobile terminals. Said base stations SRB perform also the management of the main radio resources as, for instance, the internal power control. Inside the access subsystem STA there is also comprised a radio controller of the network CRR, in the UMTS Standard called Radio Network Controller. Said radio controller CRR has the complete control of all the radio resources of its domain, that is the base stations SRB connected to it through a suitable controller-stations interface (Iub).

The Radio Network Controller CRR controls the operation of one or more base stations SRB, manages the setting up of the radio channels (establishment and release of the connections), the frequency-hopping, the internal hand-over and other functions, interconnecting with the transport subsystem STU, in particular with the Mobile services Switching Center MSC. In a large urban area there are present a lot of radio base stations SRB, controlled by a few Radio Network Controllers CRR.

In FIG. 2 there is described in better detail a mobile terminal (1): the data and voice signal exchanged with the access subsystem STA of said mobile phone network, is received by means of an antenna (10) and a receiving and transmitting block (8), connected to a microprocessor (5).

Said microprocessor (5) controls the operation of the whole mobile terminal (1), accessing a memory (6) and retrieving the information to be displayed onto a display (3) or inserting the data inputted by means of the keyboard (4) of said mobile terminal. The task of the microprocessor is also that of controlling an audio circuit (9) necessary for reproducing, via a loudspeaker (11), and receiving, via a microphone (12), the voice signal. Said audio circuit comprises therefore an interface (91) for exchanging information with said microprocessor (5), a circuit DSP (Digital Signal Processor) (92) for processing the signals, an amplifier (93) and further means (94) to convert the voice signal of the user of said mobile terminal into an electric signal, which can be processed and transmitted over said mobile phone network.

The circuits of the mobile terminal are supplied through a suitable supply system (7).

The access of said mobile terminal (1) to the network takes place through different procedures according to the different Standards (e.g. GSM, NTT, CDMA, UMTS, etc. . . ), which require a dialog between said mobile terminal and said access system STA of said mobile phone network.

In order to perform such procedures, the mobile terminal comprises an electronic card (2), apt to implement function for a controlled and authorized access to the mobile phone network. Said electronic card (2) comprises an interface (21), through which it exchanges information with the microprocessor (5) of said mobile terminal (1).

Additionally, said electronic card (2) comprises memory areas (23) (e.g. ROM, RAM, EEPROM), wherein there are contained data of various kind, organized according to a structure, which, in general terms, follows that defined in the Standard used in the mobile phone network accessed through said electronic card (2). The memory areas are therefore organized as a database with a main file (Masterfile—MF), a number of directories (DF) and a plurality of files (FF), which may have a different extension.

A microprocessor (22), also comprised in said electronic card, programmable in various languages, such as Java, interrogates said memory areas (23) and retrieves the information, which is in turn requested by the microprocessor (5) of said mobile terminal.

The electronic card being programmable, allows to organize the memory areas (23) of the electronic card in a way to foresee, besides the EF files provided by the Standards, (such as for the GSM there are used files with the extensions ADN, MSISDN, LND, FDN, SDN, BDN), also other functions and data, in particular personal data of the owner of the electronic card (2).

Advantageously, it is possible to insert, in the database of said electronic card (2), data strings which are interpreted by the microprocessor (5) of said mobile terminal (1) as operations to be executed, such as the activation of special bells when receiving a message or a call.

In the known solutions, in order to assure a safe and controlled access to a mobile phone network, the electronic card, such as the SIM card of the GSM Standard, contains a PIN code (Personal Identification Number), which is required when switching on the mobile terminal (1), so that only the owner of the card may use it.

Without said PIN code, or without the electronic card (2), the mobile terminal (1) is blocked, and you may only make emergency calls to a special number, agreed international level, which is memorized in a memory area of said mobile terminal. In the following we will refer to said operating condition of the mobile terminal as operation in emergency state.

When said mobile terminal (1) operates in emergency state, the number dialed by the user is compared to the emergency memorized number and, if they correspond, the phone unblocks and a call takes place to said emergency number.

The operation of the mobile terminal (1) in the emergency state is in any case limited, for instance the user cannot access the memory areas (6) of the mobile terminal or the memory areas (23) of the electronic card (2). This fact jeopardizes the possibility of a targeted aid in all the situations.

The electronic card according to the invention is therefore realized in a manner so as to overcome said problems, and in particular, the memory areas (23) and the processor (22) of said electronic card (2) are apt to implement additional aid functions in comparison with those which are possible with the common SIM cards, or the known SIM-H of the patent DE 199 57 651.

According to the invention, switching on the mobile terminal, the personal identification code (PIN) is not requested immediately, but the need for a first aid is verified, just as in the case of a mobile terminal without an electronic card. However, while in the prior art this check is made by the microprocessor (5) of the mobile terminal, according to the invention, in presence of an electronic card (2) with the aid functions, this check is made by the electronic card itself.

Adding this phase in the set up procedure of the electronic card (2) with the aid function, offers a number of advantages due to the fact that in an emergency case said card is not completely blocked, but allows the execution of a series of first aid functions.

If there is no need of aid, the Standard procedure of the electronic card will then be started, starting with the request of the personal identification code (PSIN).

Otherwise, according to the invention, once verified the actual need of first aid, when the electronic card (2) with the aid function is interrogated by the microprocessor (5) of the mobile terminal, the card outputs instructions which cause the displaying on the display (3), of said mobile terminal (1), of the personal data contained in said memory areas (23) of the electronic card (2) with the aid functions. It is therefore clear that, even if the mobile terminal should not be able to transmit any signal through the mobile phone network, for instance due to lack of radio coverage, or a broken antenna (10), the person which happens to be there for first aid can learn useful information.

Furthermore, according to a preferred implementation of the invention, the microprocessor (22) of the electronic card will provide the transmission of the personal data, contained in the memory areas (23) of said electronic card (2) with first aid functions, into the memory areas (6) of the mobile terminal. This function, which can be executed according to known procedures, which are used when the mobile terminal is not in the emergency state, allows to transmit the personal data of the person to be aided from the memory areas (23) of said electronic card (2) to the memory areas (6) of said mobile terminal (1). In fact, if the mobile terminal of the person to be aided is inoperative, the person giving the first aid can retrieve the electronic card (2) with the aid functions of the person to be aided, insert it into his or her mobile terminal, and find the data downloaded on it, so as to easily consult them, even if he or she should reinsert his or her SIM card.

Furthermore, being the electronic card (2) with the aid functions, at least in part operative, it allows to make calls to a first aid center and to send the personal data of the person to be aided even if the phone is in emergency state.

Advantageously, according to the invention, once verified the need of an aid, the mobile terminal makes a first aid call and/or sends a first aid message (for instance of the SMS, MMS or video message type) to a service center.

Furthermore, according to the invention, before making the call to a first aid center or to a service center, an additional decisional phase can be provided, wherein it is possible to choose the type of requested help, such as choosing between “getting lost” and “medical aid”.

Depending on the choice, help calls will be automatically activated, wherein the addressees and the activation method of the help calls will differ depending on the requested type of help. In FIG. 3 it is shown a system architecture used for realizing the system and implementing the method according to the invention, and in particular the case where a medical aid is required. In FIG. 3 the reference number 301 indicates a mobile terminal, such as a cellular phone, equipped with an electronic card (302) with the aid functions and a display (303), that is a device with the function of making visible a number of pieces of information.

Once a medical aid has been requested, through one of the previously described procedures, a call is automatically activated, and/or a help message is sent to a service center (304) the number of which has been memorized in the electronic card (302) with the aid functions (302), together with other helping information (305) such as:
Name
Surname
Mother tongue or known languages
Sex
Date of birth
Address
Blood group
Handicaps, if this is the case
Allergies
Pace-maker
Family doctor
Telephone numbers to be contacted in case of emergency
etc . . .

In an advantageous implementation form of the invention together with the request of help (by means of a call and/or SMS/MMS/video message), a piece of information can be sent to the service center (304) relating to the location of the person to be aided.

According to the invention the location can be detected in many ways, such as if the mobile terminal is equipped with a GPS system, the content of the message generated by the mobile terminal may contain the coordinates of the calling mobile terminal and therefore of the lost person. However mobile terminal incorporating GPS systems are not yet widespread, and usually used for special purposes as the rescue of people in the mountains.

According to a preferred implementation of the method, the position of the user is automatically detected by suitable means of the mobile phone network, when a first aid call is activated or a help message is sent by said mobile terminal with said electronic card (302) with the aid functions. In particular, the mobile phone networks comprise in the transport subsystem an MSC (mobile Switching Center), containing a number of databases, among them the VLR (Visitor Location Register) and the HRL (Home Locator Register), where records are stored with the information of the radio base station(s) offering a coverage of the area where the mobile terminal is located.

In the case of many radio base stations covering the same area, it is therefore possible, for example by superimposing the coverage areas of the cells, to determine a narrow area where the mobile terminal with the card with the aid function is located. The location data according to the present invention, is then automatically calculated by the mobile phone network operator in the moment when a message or a call coming from an electronic card (302) with the aid function forwarded to the service center (304), is registered and then transferred to said service center (304).

The main task of said service center (304) is that of identifying the calling electronic card (302) with the aid function, retrieving the relevant help information (305) and send them, together with the location data, to a help center (306) through a connection (307) preferably, but not exclusively, of a wired type.

Together with the forwarding of information to the help center (306), the service center (304) activates automatically, or by means of an operator, a conference call (310), wherein the calling mobile terminal (301) with the electronic card (2) with the aid function, the help center (306), and one or more telephone users (308, 309) to be contacted in emergency cases, are put in connection. Such numbers are contained in the help information available at the service center, previously indicated by the owner of the electronic card (302) with the aid function. With the above described system and relevant method, in case of a serious accident, a person which happen to give the first aid can retrieve the electronic card (302) with the aid function of the injured person. Said card can possibly be worn around the neck or be inserted in a mobile phone; the aiding person can insert it into his or her mobile terminal, such as a mobile phone, and press the key for a medical aid request.

The activation of the conference call (310) with the help center (306) and the people (308,309) previously indicated by the owner of the electronic card (302) with the aid function, that is by the person to be aided, allows the rescuers to receive additional information about the person to be aided and the type of the accident. The latter pieces of information cannot be stored in advance neither in the service center, nor in the card with the aid function.

In FIG. 4, it is shown a second system architecture used for implementing the invention, in particular in the case when a medical aid is not necessary, but only the fact that someone got lost has to be communicated.

The electronic card (2, 302) with the aid function according to the invention can be used in various situations and not only for requesting a medical aid; for instance the owner of an animal or the parent of a child can think of using the electronic card (2, 302) according to the invention in the case that the animal or the child got lost.

The mobile terminal of FIG. 4, once verified the need of help and that the type of help requested is a loss signaling, calls one after the other a list of telephone numbers (308,309) memorized in said electronic card (302) with the aid function, until at least one of said numbers replies to the call, or until the list of numbers is over. In the latter case, it is called a telephone number of the armed force, such as the police (311), or the like.

Also in this case the advantages of the system and the method according to the invention are clear: in case of loss of someone who is not able to indicate his or her identity, such as an animal or a child or also an aged or ill person, the first rescuer can retrieve said electronic card with the aid function, which the lost being has with oneself (e.g. inserted in a collar or in a bracelet) and insert it into his or her own mobile terminal.

The rescuer is then put in contact with a person, which answers to the telephone number called through the electronic card (302) with the aid function, and can come and retrieve the lost being. In this way it is avoided to overcharge the call centers of the police with calls, which may be manage in a different way. Furthermore, the direct contact with a person who knows the lost being allows the rescuer to hear useful news in the case that the lost being is injured or needing particular care, for instance medicines.

Further advantages can be obtained according to a preferred form of implementation of the invention, wherein when the list of the telephone numbers stored onto the electronic card is over, the call to the armed force is replaced with the forwarding of a SMS (Short Message Service) message to a service center, indicated in FIG. 4 with the reference number 304, or to the same stored telephone numbers which are able to receive SMS messages.

It is in any case clear that the possibility of choosing the type of the help, avoids overloading the police call center, which may so be relieved from a part of the first aid calls, in the case of calls concerning a lost animal or child or aged person.

Advantageously, even if the network coverage is missing, the possibility of looking at help information on the display of the mobile terminal, allows an easy identification of the lost being, animal or person, and gives the possibility to call the emergency telephone numbers from a fixed telephone.

From the present description it is then clear which are the advantages of the system and the method in managing emergency situations through a mobile terminal according to the invention.

It is also clear that many variations are possible for the person skilled in the art without leaving the teachings of the present invention; for instance, for improving the manufacturing costs of said electronic card (2, 302) with the aid function, or increasing the number of the help information stored on said card (2, 302) with the aid function, and keeping the manufacturing cost unchanged, we can think of realizing an electronic card (2, 302) exclusively directed to the aid functions, which does not allow all the normal functions of the cards commonly used for accessing the mobile phone networks.

Reducing the complexity of the electronic card (2, 302) with the aid function, such as removing or reducing the size of the memory areas for storing telephone numbers or names (address book), we can save manufacturing cost or decide to use the available memory areas for storing help information.

Finally, for the sake of the description completeness, the insertion of the helping information (personal data and telephone numbers to be called in emergency cases) in the electronic card (2, 302) with the aid function may be made in various manners:
through manual insertion by means of the mobile terminal keyboard;
through an external apparatus;
through programming from the service center via radio.

In order to have a control about the correspondence of the help information on the electronic card (2, 302) with the aid function with those in the service center, the preferred solution is that of storing or updating said information on the control card by means of the transmission of codes, such as data strings of an SMS message, transmitted from the service center to the mobile terminal where the electronic card (2, 302) with the aid function has been inserted for the first memorization or for the updating of the help information.

Advantageously, the electronic card (2,302) with the aid function can be suitably programmed in the way that the first time that it is inserted into a mobile terminal, it makes a call to a service center for any reason, for instance for:

1. verifying the efficiency of the electronic card (2,302) with the aid function;

2. activating the electronic card (2,302) with the aid function;

3. uploading of the help information, such as personal data and list of the telephone numbers to be called;

4. transmission, if necessary, from the service center, of a list of the procedures to be followed for storing the help information into the electronic card (2,302) with the aid function (procedures which are not necessary if the card with the aid functions has already been loaded by means of a suitable external apparatus at the moment of the purchasing).

1. A system for the management of emergency situations, the system comprising:
a mobile terminal equipped with an electronic card apt to implement access functions to a mobile phone network, the electronic card comprising memory areas containing personal data of an owner of said electronic card;
wherein said electronic card has aid functions, which make the electronic card at least partially operative when said mobile terminal is operating in emergency conditions.

2. The system according to claim 1, wherein said mobile terminal includes a display and said aid functions comprise a function of visualization of said personal data on the display of said mobile terminal.

3. The system according to claim 1 or 2, wherein said mobile terminal includes a memory area and said aid functions comprise a function of transferring said personal data into the memory area of said mobile terminal.

4. The system according to claim 1 or 2, wherein said electronic card is provided with a personal identification code.

5. The system according to claim 4, wherein said electronic card, before checking said personal identification code, verifies whether there is a need for medical aid, or a need for signaling that someone got lost.

6. The system according to claim 5, wherein said electronic card allows choosing between a need for medical aid and a need to signal that someone got lost.

7. The system according to claim 5, wherein said mobile terminal includes a keyboard and a need of aid is indicated through pressing a key on the keyboard of said mobile terminal.

8. The system according to claim 5, wherein if there is a need of medical aid, said electronic card enables forwarding of a message to a service center.

9. The system according to claim 5, wherein if there is a need of medical aid, said electronic card enables a call to a service center.

10. The system according to claim 8, further comprising said mobile phone network, wherein the forwarding of said message to said service center is detected by suitable means of said mobile phone network, and further means of said mobile phone network provide for detecting a position of said mobile terminal.

11. The system according to claim 9, further comprising said mobile phone network, wherein said call to said service center is detected by suitable means of said mobile phone network, and further means of said mobile phone network provide for detecting a position of said mobile terminal.

12. The system according to claim 10 or 11, wherein said position is sent to said service center.

13. The system according to claim 5, further comprising a service center that includes a database containing personal data of the owner of said electronic card, and wherein if there is a need of medical aid, said electronic card enables forwarding of a message to said service center.

14. The system according to claim 13, wherein said service center transmits said personal data to a first aid center.

15. The system according to claim 13, wherein said service center transmits said personal data and a position of said mobile terminal to a first aid center.

16. The system according to claim 14, wherein said service center connects said mobile terminal to said first aid center.

17. The system according to claim 13, wherein said personal data comprise telephone numbers to be contacted in case of emergency.

18. The system according to claim 17, wherein said service center connects said mobile terminal to one or more of said telephone numbers to be contacted in case of emergency.

19. The system according to claim 17, wherein said service center connects said mobile terminal to a first aid center and to one or more of said telephone numbers to be contacted in case of emergency.

20. The system according to claim 5, wherein telephone numbers to be contacted in case of emergency are stored in said electronic card, and if it is necessary to signal that somebody got lost, said electronic card enables the telephone numbers to be called one after the other in a sequence of calls.

21. The system according to claim 20, wherein said sequence of calls is terminated when an answer is received from one of said telephone numbers to be called in case of emergency.

22. A method for the management of emergency situations through a mobile terminal equipped with an electronic card apt to implement functions for accessing a mobile phone network, the electronic card comprising memory areas containing personal data of an owner of said electronic card, the method comprising:
a first phase of inserting said electronic card into said mobile terminal;
a second phase of switching on said mobile terminal; and
a third phase of checking whether aid is necessary, said third phase preceding a request of a personal identification code of said electronic card.

23. The method according to claim 22, further comprising, if there is need of aid, visualizing said personal data on a display of said mobile terminal.

24. The method according to claim 22 or 23, further comprising, if there is need of aid, transferring said personal data into a memory area of said mobile terminal.

25. The method according to claim 22 or 23, wherein before verifying a personal identification code, said electronic card checks whether medical aid is necessary or somebody got lost.

26. The method according to claim 25, wherein said electronic card allows choosing between a need for medical aid, and a need to signal that somebody got lost.

27. The method according to claim 25, further comprising indicating a need of an aid by pressing a key on a keyboard of said mobile terminal.

28. The method according to claim 25, wherein if aid is necessary, said electronic card enables forwarding of a message to a service center.

29. The method according to claim 25, wherein if aid is necessary, said electronic card enables a call to a service center.

30. The method according to claim 28, wherein suitable means of said mobile phone network detect the forwarding of said message to said service center, and further means of said mobile phone network provide for detecting a position of said mobile terminal.

31. The method according to claim 29, wherein suitable means of said mobile phone network detect said call to said service center, and further means of said mobile phone network provide for detecting a position of said mobile terminal.

32. The method according to claim 30, wherein said position is transmitted to said service centers.

33. The method according to claim 28 or 29, wherein said service center includes a database with personal data of the owner of said electronic card.

34. The method according to claim 33, further comprising transmitting said personal data from said service center to an aid center.

35. The method according to claim 33, further comprising transmitting said personal data and a position of said mobile terminal from said service center to an aid center.

36. The method according to claim 34, wherein said service center connects said mobile terminal to said aid center.

37. The method according to claim 33, wherein said personal data comprise telephone numbers to be called in case of emergency.

38. The method according to claim 37, wherein said service center connects said mobile terminal to one or more of said telephone numbers to be called in case of emergency.

39. The method according to claim 37, wherein said service center connects said mobile terminal to an aid center and to one or more of said telephone numbers to be called in case of emergency.

40. The method according to claim 25, further comprising storing telephone numbers to be contacted in case of emergency in said electronic card, and if it is necessary to signal that somebody got lost, said electronic card calls the telephone numbers one after the other in a sequence of calls.

41. The method according to claim 40, further comprising terminating said sequence of calls when an answer is received from one of said telephone numbers to be called in case of emergency.

42. (canceled)

43. A system implementing the method according to claim 22.

44. An electronic card for use in association with a mobile terminal and apt to implement access functions to a mobile phone network, the electronic card comprising memory areas containing personal data of an owner of said electronic card, and wherein the electronic card is equipped with aid functions, which make the electronic card operative at least in part, when said mobile terminal operates in an emergency state.
